(19) United States
(12) Patent Application Publication
(10) Pub. No.: US 2006/0004853 A1
(43) Pub. Date: Jan. 5, 2006

(54) Method and system to prefilter and render service data utilizing trigger links

(76) Inventor: Michael Danninger, Landau (DE)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/846,118

(22) Filed: May 14, 2004

(51) Int. Cl. G06F 17/00

(52) U.S. Cl. 707/103 Y

(57) ABSTRACT

A method and system to prefilter and render service data utilizing trigger links are disclosed. Trigger links allow users to navigate to a table, which is automatically filtered according to a filter associated with the trigger link. A user is provided with a short cut in an exemplary form of a trigger link, such that the user is not being forced to explicitly apply a filter to the table. For each filter possibility, a distinct trigger link is offered. A trigger link is configured to access a service capable of providing a table responsive to the user activating the trigger link, filtering the table according to parameters associated with the trigger link, and rendering the filtered table to the user.

### FIELD OF THE INVENTION

One exemplary embodiment relates generally to enterprise resource and program management, and more particularly to a method and system to prefilter and render service data utilizing trigger links.

### BACKGROUND OF THE INVENTION

With human resources and other service-oriented departments seeking to ease their day-to-day administrative work-loads and concentrate their efforts on the essentials, software applications have been developed to enable companies to move forward. For instance, there are software tools in existence that allow users to perform a number of personnel-related tasks in information technology (IT) systems themselves.

In a portal environment, a user may have access to a variety of information. Such access may be provided utilizing a web link, e.g., a URL identifying the location of the web page containing the desired information. For example, a user who is a manager may wish to access information regarding their employees' profiles. A user may be able to utilize a web link in order to navigate to a web page containing the relevant information.

### SUMMARY OF THE INVENTION

In one embodiment, a method and system to prefilter and render service data utilizing trigger links include a page processor to receive a web link request from a user; a dispatcher to identify a service associated with the web link request and to identify filter parameters, if any, associated with the web link request; an extractor to identify service data associated with the service; a filter to generate filtered service data in accordance with the filter parameters responsive to the identifying of the filter parameters; and a view generator to generate a view in accordance with the filtered service data. The system further include a display module to communicate the filtered service data to the user.

Other features of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which:

FIG. 1 is a network diagram illustrating a system having a client-server architecture, according to one embodiment of the present invention;

FIG. 2 is a diagram illustrating functional layers of a server system, according to one embodiment of the present invention;

FIG. 3 is a flowchart illustrating a method to prefilter and render a table utilizing trigger links, according to an embodiment of the present invention;

FIG. 4 is an exemplary user interface utilizing trigger links, according to one embodiment of the present invention.

FIG. 5 is a flow diagram illustrating operations performed responsive to a trigger link activation, utilizing a model view controller design pattern, according to one embodiment of the present invention.

FIG. 6 is a diagrammatic representation of a computer system, within which a set of instructions, for causing the machine to perform any one or more of the methodologies discussed herein, may be executed.

### DETAILED DESCRIPTION

A method and system to prefilter and render service data utilizing trigger links are described. In the following description, for purposes of explanation, numerous specific details are set forth in order to provide a thorough understanding of the present invention. It will be evident, however, to one skilled in the art that the present invention may be practiced without these specific details.

In a portal environment, a service available to a user may utilize a homepage concept to facilitate maximum user convenience. On a homepage, a service may be introduced briefly, while links may be offered to allow the user to access various functionality available within the service. For example, in a staff management system context, a service related to employee attendance monitoring may allow a user to view a homepage that briefly describes functionality available within this service, as well as to access information related to employee attendance history, attendance for all employees on a specific date, as well as other functionality.

A good user experience may result from efficient navigation. For example, in staff management system context, a user may wish to navigate directly to attendance overview page and may wish to bypass an associated homepage. A capability of allowing a user to access a service or an aspect of the service directly, without first accessing the associated homepage, may be accomplished by utilizing quick links. In a staff management system context, a user interface may be provided including quick links.

In another scenario, a user may wish to view a particular segment of attendance information, such as attendance information for a particular date. To accomplish this, the attendance information available within the employee attendance monitoring service may be filtered according to the user's need and then presented to the user (e.g., in a tabular form). Links for rendering tables that are being prefiltered from a different page (e.g., trigger links) may be utilized to support this functionality.

Trigger links may allow users to navigate to a table, which is automatically filtered according to a filter associated with the trigger link. Thus, the user is provided with a short cut in an exemplary form of a trigger link, and is not being forced to explicitly apply a filter to the table. Thus, the filtering may be done implicitly using the relevant trigger link. For each filter possibility, a distinct trigger link may be offered. A trigger link may be configured to access a service capable of providing a table responsive to the user activating the trigger link, filter the table according to parameters associated with the trigger link, and render the filtered table to the user.

Trigger links may be used in web services, such as, for example, employee self services, manager self services, and other web services. Trigger links may be utilized in a portal environment.

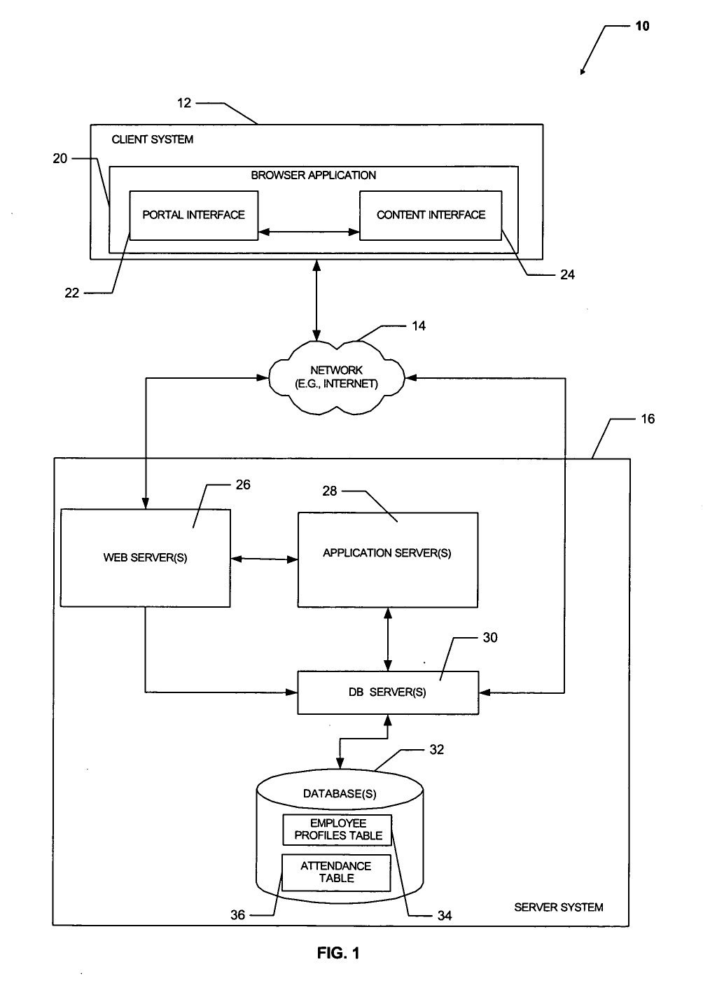

FIG. 1 is a network diagram depicting a system 10, according to one exemplary embodiment of the present invention, having client-server architecture. A client system 12 is coupled via a network 14 (e.g., the Internet or an intranet) to a server system 16, so as to facilitate communications (e.g., utilizing any one of a number of well-known network communication protocols, such as HTTP) between the client system 12 and the server system 16. The client system 12 may further host a number of client applications, such as a browser application 20 (e.g., MS EXPLORER®, developed by Microsoft Corporation of Redmond, of Washington State). The browser application 20 may include a portal interface 22 and a content interface 24.

In one exemplary embodiment, the portal interface 22 may facilitate user access to one or more applications hosted on the application server 26, such as employee self service application.

The portal interface 22 is shown to invoke the content interface 24 within which content associated with a web-based application may be presented to a user. Specifically, the content interface 24 may communicate with the one or more applications hosted on the application server 26, at least one of which may be responsible for the delivery of content to the content interface 24. Both the portal interface 22 and the content interface 24 may communicate with the server system 16 via the network 14.

The server system 16, in one exemplary embodiment, may include a web server 26, an application server 28, and a database (DB) server 30. The database server 30 may be connected a database 32. The application server 28 may be deployed to support one or more applications, and may utilize the database server 30 to store and to retrieve data from a database 32. The database 30 may, for example, store data such as employee information in an exemplary form of employee profiles table 32, user attendance information in an exemplary form of attendance table 34, and other information. The data within the database 32 may be stored in any one of a number of forms, such as, for example, flat files, relational tables objects, or as XML (eXtensible Markup Language) data structures. The application servers 26 may also be coupled to one or more web servers 36, so as to facilitate the delivery of web content, including content containing embedded code, such as Java, to the portal interface 22 and the content interface 24.

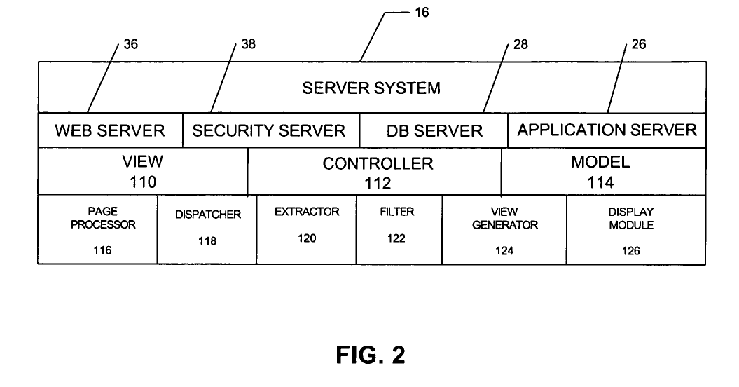

FIG. 2 is a diagram illustrating functional layers of the server system 16, according to an embodiment of the present invention. As described with reference to FIG. 1, the server system 16 may include the web server 36, the database (DB) server 28, and the application server 26. A view 110, a controller 112, and a model 114 make up an exemplary construct within the server system 16 for processing trigger links relevant portions of user interface code within the server system 16. The view 110 may also be shared in part by the client system 12, wherein data related to a service associated with a particular trigger link is passed from the view 110 to the controller 112 responsive to a user's activating a trigger link. In one exemplary embodiment, the model 114 represents source code, such as the source code responsible for identifying a service associated with the trigger link, identifying the service data and filtering the service data according to the trigger link associated filter. The source code for processing a request associated with a trigger link may be called by Java Server Pages (JSP).

In one exemplary embodiment, trigger links functionality, may be accomplished by utilizing a page processor 116, a dispatcher 118, an extractor 120, a filter 122, a view generator 124, and a display module 126. When a user activates a trigger link (e.g., by clicking on the trigger link), a portal navigation event is triggered. A filter parameter is passed to the backend and the data is filtered according to the filter parameter associated with the trigger link. If the model view controller (MVC) design pattern is utilized, a method to filter the data according to the filter parameter may be defined in the model part of the MVC. The controller part of the MVC may pass the filtered data to the client (e.g., by rendering a new web page).

In operation, the page processor 116 receives a trigger link request from a user and may trigger a portal navigation event. The page processor 116 passes the request to the dispatcher 118 and the dispatcher 118 identifies a service associated with the trigger link request. In one embodiment, the service identifier may be embedded in the URL associated with the trigger link. The dispatcher 118 further identifies filter parameters associated with the web link request. In one embodiment, the filter parameters may be embedded in the URL associated with the trigger link.

The extractor 120 identifies service data associated with the service and the filter 122 generates filtered service data in accordance with the filter parameters. Once the filtered service data is generated, the view generator 124 generates an appropriate view in accordance with the filtered service data. The display module 126 may be utilized to communicate the filtered service data to the user. The filtered service data may be communicated to the user in the form of an HTTP page.

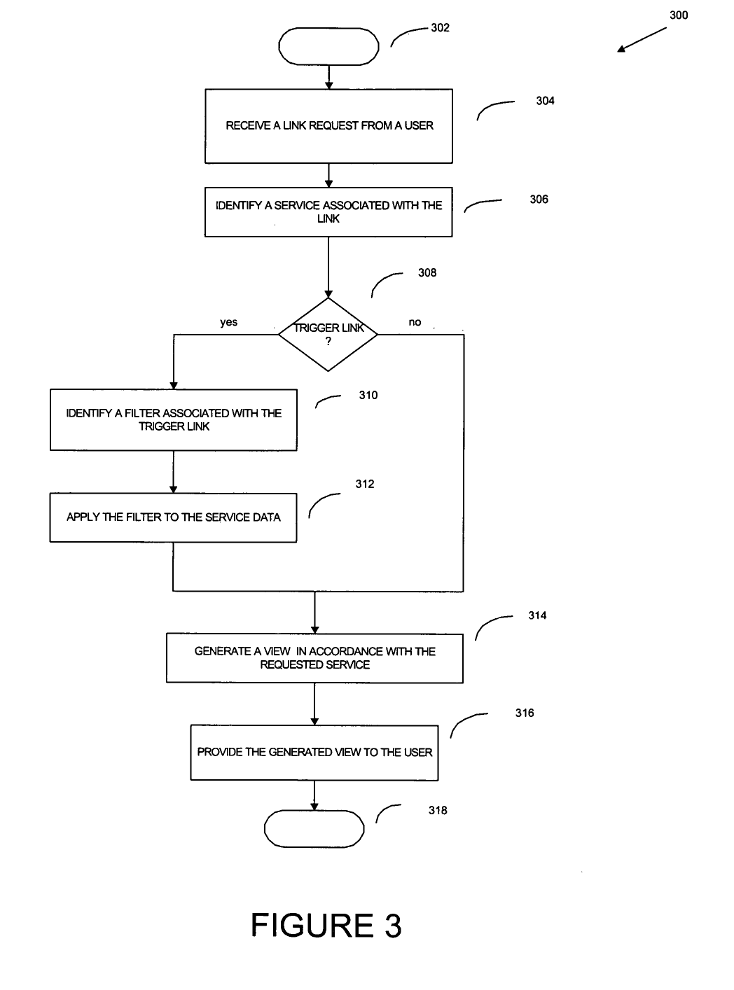

FIG. 3 is a flow chart illustrating a method 300 to pre-filter and render a table utilizing trigger links. When a user, operating at the client 12 within the portal interface 22, clicks on a link, the click triggers an event associated with the link and invokes a navigation method associated with the event. The navigation method produces a web page associated with the service identified by the link. The resulting web page includes some or all of the data available for this service. The data displayed to the user in response to activating a trigger link (e.g., by clicking on the trigger link) may be filtered according to filtering parameters associated with the trigger link.

For example, in the context of a manager self service system, a user may invoke attendance service to view attendance records of all employees. Alternatively, a user may choose to view only attendance records related to those employees who are currently at work. A user may invoke a corresponding link (e.g., a corresponding trigger link), which would result in a web page listing only those employees who are currently at work. Thus, a trigger link may be utilized to enable a user to view service data (e.g., an attendance table) where the content is limited according to the filters associated with the trigger link (e.g., only records related to those employees who are currently at work, or to employees who are temporarily absent).

Returning to FIG. 3, the method 300 commences at operation 302. At operation 304, a link request is received at the server system 16. The service associated with the trigger link is identified at operation 306 (e.g., by parsing the URL string associated with the trigger link). If it is determined at operation 308 that the link request is a trigger link request, then a filter associated with the trigger link is identified at operation 310 and the filter is applied to the service data at operation 312. At operation 314, a view is generated in accordance with the requested service associated with the link. The view generated at operation 314 may include a tabular representation of the filtered data (e.g., a table). If it is determined at operation 308 that the link request is not a trigger link request, then the method 300 proceeds directly to generate a view at operation 314 in accordance with the service associated with the request, and to communicate the view to the user. The view communicated to the user may be in a form of an HTTP web page. The view provided to the user may also be in a form of a dynamic web page. The method concludes at operation 318.

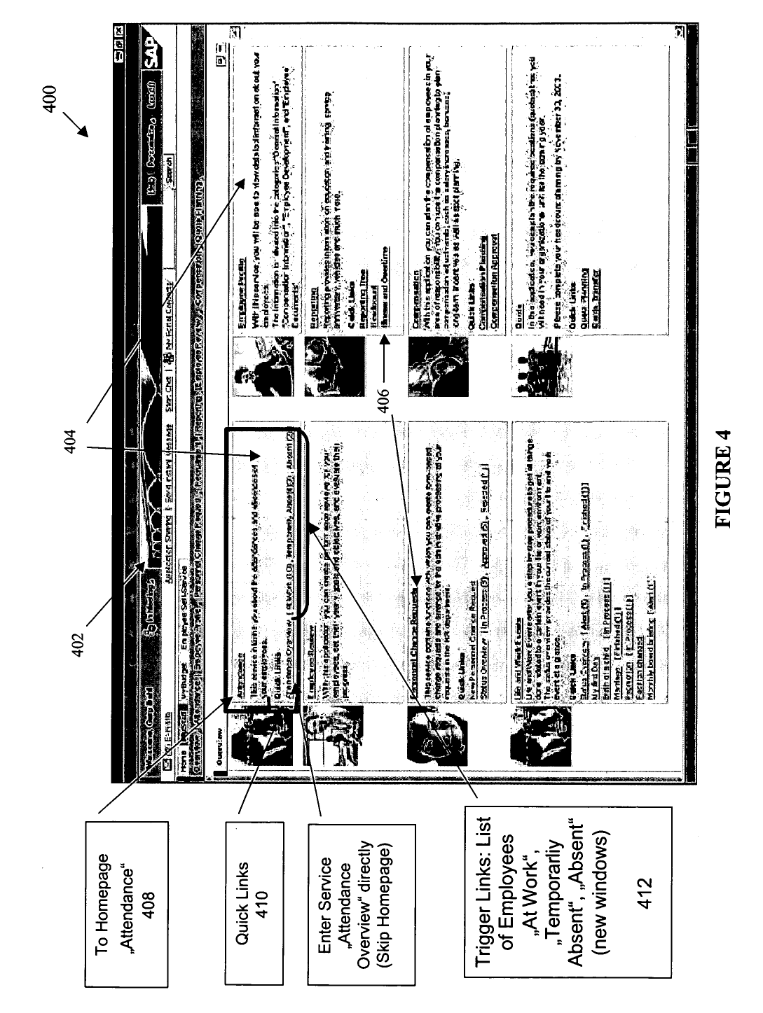

FIG. 4 is an exemplary user interface 400, including trigger links according to one embodiment of the present invention. The user interface 400 (here, an exemplary resource management interface) may be represented by a web page including a header 402, service areas 404, and a number of links 406. The service areas 404 may enable a user (e.g., a manager) a variety of services. For example, the services accessible from the service areas may allow a user (e.g., a manger) to view employee attendance, to create and perform reviews for employees, and to view personnel change requests. Other services provided within the user interface 400 may include a life and work events service, an employee profile service, a reporting service, a compensation service, a quota service, and other services. Each service area 404 may include one or more links 406 to enable a user to access various services as well as a variety of information available within the services.

In FIG. 4, a service area 404 may include a link to the service homepage 408 to allow a user to access the service homepage, one or more quick links 410 to allow a user to access a particular aspect of the service while bypassing the service homepage, and one or more trigger links 412 to allow a user to access a particular portion of the service data. For example, the attendance service area displayed within the user interface 400 includes the “Attendance” link to allow a user to access “Attendance” homepage, the “Attendance Overview” quick link to allow a user to access attendance overview page bypassing the associated homepage, and trigger links “At Work”, “Temporarily Absent” and, “Absent”. It will be noted that the links 406 may be configured to result is information being displayed in the associated service area, or alternatively, in a separate window.

Specifically, trigger links may provide a quick and convenient way for a user to access a particular segment or relevant information. For example, a trigger link “At Work” will automatically activate a filter that would select only information regarding the employees that are currently at work and provided to a user. A trigger link “Temporarily Absent” may allow a user to view only the names of employees who are temporarily absent. Similarly, a trigger link “Absent” may allow a user to view only information related to employees who are absent.

It will be noted that although trigger links are illustrated within an exemplary user interface 400, trigger links may be provided within a great variety of user interface designs.

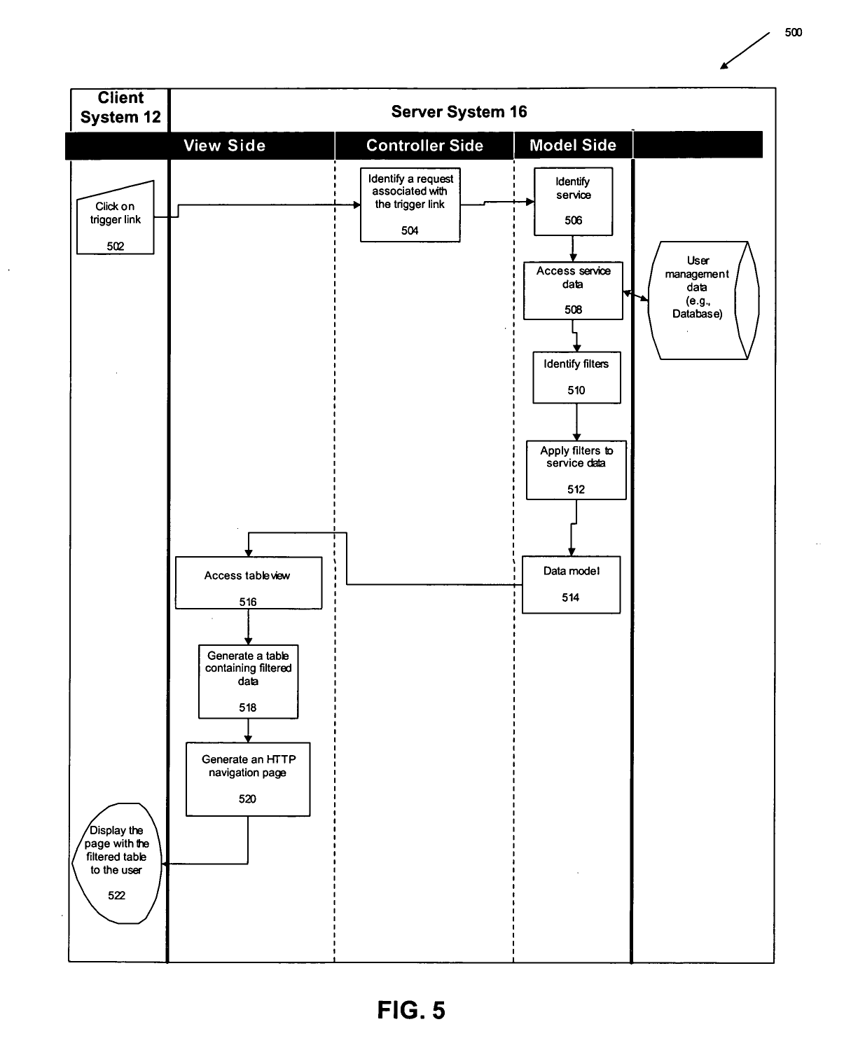

The functionality of a trigger link may be implemented, for example, utilizing a model view controller (MVC) design pattern. FIG. 5 is a flow diagram illustrating operations performed responsive to a trigger link activation, utilizing a model view controller design pattern, according to one embodiment of the present invention. FIG. 5 illustrates a method 500 to utilize trigger links in one exemplary embodiment of the present invention. The method 500 commences in the client system 12 when a user activates (e.g., clicks on) a trigger link 412 of FIG. 4. When a user clicks on a trigger link 412 at operation 502, the controller side of the server system 16 receives the request associated with click at operation 504, and passes control to the model side of the server system 16. The method 500 then identifies a service associated with the trigger link at operation 506, accesses service data at operation 508, and identifies filtering parameters associated with the trigger link at operation 510. Referring to the exemplary embodiment illustrated in FIG. 4, when a user activates the “At Work” trigger link, the service associated with the trigger link is the “Attendance” service within the employee management system. The method 400 accesses the attendance service data, which may relate, for example, to employees' attendance and may be stored within a database 32 of FIG. 1.

Once the data available within the service (e.g., employees' attendance data) is identified and accessed, and the filtering parameters are determined the method 500 filters the service data in accordance with the filter parameters to generate filtered data at operation 512. It will be noted that the operations 506, 508, and 510 may be performed in any order. Referring to FIG. 4, the filter associated with the trigger link “At work” will identify the information related to employees who are currently at work such that only the information related to employees who are currently at work may be presented to the user. At operation 514, a data model suitable for representing attendance information is created or accessed.

The data model identified at operation 514 may be utilized to generate or access a view (e.g., a table view) suitable for representing the employee attendance data at operation 516. At operation 518, a table containing the filtered data is generated by the method 500, utilizing the data model identified at operation 514 and the table view identified at operation 516. Once a table containing the filleted data is generated, the view side of the server system 16 generates an appropriate HTTP navigation page at operation 520. The view side then allows the HTTP navigation page to be displayed to the user at operation 522.

It will be noted that although the operations of method 300 of FIG. 3 and the operations of method 500 of FIG. 5 are illustrated to be in a particular order, this order does not have to be strictly followed in order to implement trigger links functionality. For example, an operation of accessing the service data may follow an operation of identifying the filtering parameters associated with the trigger link.

The method 500 of FIG. 5, in one exemplary embodiment, may employ Enterprise JavaBeans (EJB) or Java classes at the model layer, HTML and JavaServer Pages (JSP) at the view layer, and servlets at the controller layer. Although FIG. 5 illustrates the method 400 utilizing the MVC design pattern, it will be noted that trigger links functionality may be implemented in a pattern where the view and the controller are encapsulated in the same object or utilizing a design pattern distinct from the MVC design pattern.

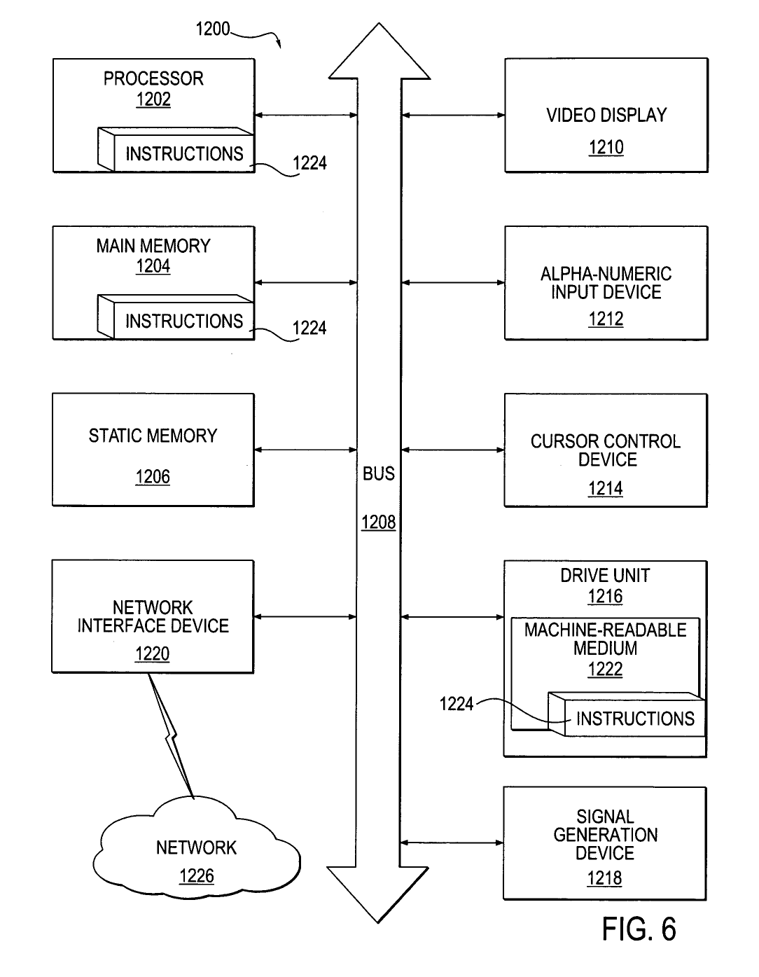

FIG. 6 illustrates a diagrammatic representation of machine in the exemplary form of a computer system 1200 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 1200 includes a processor 1202 (e.g., a central processing unit (CPU) a graphics processing unit (GPU) or both), a main memory 1204 and a static memory 1206, which communicate with each other via a bus 1208. The computer system 1200 may further include a video display unit 1210 (e.g., a liquid crystal display (LCD) or a cathode ray tube (CRT)). The computer system 1200 also includes an alphanumeric input device 1212 (e.g., a keyboard), a cursor control device 1214 (e.g., a mouse), a disk drive unit 1216, a signal generation device 1218 (e.g., a speaker) and a network interface device 1220.

The disk drive unit 1216 includes a machine-readable medium 1222 on which is stored one or more sets of instructions (e.g., software 1224) embodying any one or more of the methodologies or functions described herein. The software 1224 may also reside, completely or at least partially, within the main memory 1204 and/or within the processor 1202 during execution thereof by the computer system 1200, the main memory 1204 and the processor 1202 also constituting machine-readable media. The software 1224 may further be transmitted or received over a network 1226 via the network interface device 1220.

While the machine-readable medium 1222 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, a method and system to prefilter and render service data utilizing trigger links have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A system to navigate a web service, the system including:
a page processor to receive a web link request from a user;
a dispatcher to identify a service associated with the web link request and to identify filter parameters, if any, associated with the web link request;
an extractor to identify service data associated with the service;
a filter to generate filtered service data in accordance with the filter parameters responsive to the identifying of the filter parameters; and
a view generator to generate a view in accordance with the filtered service data.

2. The system of claim 1, including a display module to communicate the filtered service data to the user.

3. The system of claim 1, wherein the view generator is to generate a tabular representation of the filtered service data.

4. The system of claim 1, wherein the system utilizes a model view controller design pattern.

5. The system of claim 1, including a user interface generator to generate a user interface to access the web service, the user interface generator including a service link, the service link being to enable the user to access a homepage associated with the web service.

6. The system of claim 5 wherein the user interface includes a quick link, the quick link being to enable the user to access an aspect of the web service, while bypassing the homepage associated with the web service.

7. A method to navigate a web service, the method including:
receiving a web link request from a user;
identifying a service associated with the web link request and filter parameters, if any, associated with the web link request; and
responsive to the identifying of the filter parameters, extracting service data in accordance with the filter parameters, thereby generating filtered service data; and
generating a view in accordance with the filtered service data.

8. The method of claim 1, including communicating the filtered service data to the user.

9. The method of claim 1, wherein the generating of the view in accordance with the filtered service data includes generating a tabular representation of the filtered service data.

10. The method of claim 1, wherein the extracting of the service data in accordance with the filter parameters is implemented utilizing a model view controller design pattern.

11. The method of claim 7, including generating a user interface to enable the user to access the web service, the user interface including a service link, the service link being to enable the user to access a homepage associated with the web service.

12. The method of claim 11, wherein the user interface includes a quick link, the quick link being to enable the user to access an aspect of the web service, while bypassing the homepage associated with the web service.

13. A user interface to navigate a web service, the user interface including:
a header to identify a web service application;
a service area to identify a service offered by the web service application;
a trigger link associated with the service to enable a user to access service data, the service data being filtered according to the trigger link parameters.

14. The user interface of claim 13 including one or more quick links, each quick link from the one or more quick links being to enable the user to access an aspect of the web service, while bypassing an associated web service homepage.

15. A method to generate a user interface, the method including:
defining a header to identify a web service application;
defining a service area to identify a service offered by the web service application;
defining a trigger link associated with the service to enable a user to access service data, the service data being filtered according to the trigger link parameters.

16. A method to navigate a web service, the method including:
means for receiving a web link request from a user;
means for identifying a service associated with the web link request and filter parameters, if any, associated with the web link request; and
means for responsive to the identifying of the filter parameters, extracting service data in accordance with the filter parameters, thereby generating filtered service data; and
means for generating a view in accordance with the filtered service data.

17. A machine-readable medium having stored thereon data representing sets of instructions which, when executed by a machine, cause the machine to:
receive a web link request from a user;
identify a service associated with the web link request and to identify filter parameters, if any, associated with the web link request;
identify service data associated with the service;
generate filtered service data in accordance with the filter parameters responsive to the identifying of the filter parameters; and
generate a view in accordance with the filtered service data.
